(19) United States
(12) Patent Application Publication
(10) Pub. No.: US 2020/0210485 A1
(43) Pub. Date: Jul. 2, 2020

(54) MULTI-QUERY ACTION ATTRIBUTION FOR CANDIDATE RANKINGS

(71) Applicant: Microsoft Technology Licensing, LLC, Redmond, WA (US)

(72) Inventors: Tanvi Sudarshan Motwani, Santa Clara, CA (US); Nadeem Anjum, Santa Clara, CA (US); Gio Carlo C. Borje, Sunnyvale, CA (US); Erik Buchanan, Sunnyvale, CA (US)

(73) Assignee: Microsoft Technology Licensing, LLC, Redmond, WA (US)

(21) Appl. No.: 16/234,388

(22) Filed: Dec. 27, 2018

(51) Int. Cl. G06F 16/903; G06Q 10/06; G06K 9/62; G06N 20/00

(52) U.S. Cl. CPC G06F 16/90335; G06N 20/00; G06K 9/623; G06Q 10/063112

(57) ABSTRACT

The disclosed embodiments provide a system for processing data. During operation, the system identifies a positive action by an entity on a candidate as a result of a query performed by the entity for a ranking of candidates. Next, the system identifies related queries that occur within a time window preceding the query. The system then generates positive labels associated with the candidate and one or more related queries that produce rankings containing the candidate. Finally, the system outputs the positive labels in training data for a machine learning model that generates the rankings.

### BACKGROUND

### Field

The disclosed embodiments relate to techniques for ranking search results. More specifically, the disclosed embodiments relate to techniques for performing multi-query action attribution for candidate rankings.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online networks may facilitate other types of activities and operations. For example, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of generating training data for a machine learning model in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for performing multi-query action attribution for candidate rankings. The candidate rankings include rankings of candidates for jobs, positions, roles, and/or opportunities. The candidate rankings may also, or instead, include rankings of recommendations of connections, follows, mentorships, referrals, and/or other types of relationships or interactions for members of an online network. Each ranking may be produced by ordering the candidates by descending score from one or more machine learning models. As a result, candidates at or near the top of a ranking may be deemed better qualified for the corresponding opportunity and/or recommendation than candidates that are lower in the ranking.

More specifically, the disclosed embodiments improve candidate rankings generated by machine learning models by attributing positive labels associated with certain queries for rankings of candidates with preceding queries with the same intent. For example, a recruiter may perform a series of queries with a hiring or recruiting product to search for candidates that match an opportunity. When the recruiter performs a positive action on a candidate (e.g., saving the candidate to a hiring project, viewing the candidate, messaging the candidate, etc.) that is shown in a ranking of candidates returned in response to one of the queries, a positive label associated with the query, recruiter, and/or candidate may be generated. The positive label may also be “transferred” from the query to previous queries by the same recruiter that also include the candidate in search results, thereby “attributing” the positive action to previous queries that were performed with the same hiring intent. The positive label and associated features (e.g., features associated with the queries, recruiter, and/or candidate) may then be inputted as training data for one or more machine learning models that produce the candidate rankings in response to the queries.

By attributing positive labels and/or outcomes across queries that are progressively reformulated to reach the outcomes, the disclosed embodiments may increase the number of positive labels and/or improve the distribution of queries in training data for machine learning models that produce rankings in response to the queries. In contrast, conventional techniques may generate training data based on strict attributions of outcomes to queries that lead directly to the outcomes, which may limit positive labels in the training data and/or generate conflicting labels for related or similar queries (e.g., a negative label for a lack of action on a candidate after a first query and a positive label for a positive action on the same candidate after a second query). Consequently, the disclosed embodiments may improve computer systems, applications, user experiences, tools, and/or technologies related to user recommendations, machine learning, employment, recruiting, and/or hiring.

### Multi-Query Action Attribution for Candidate Rankings

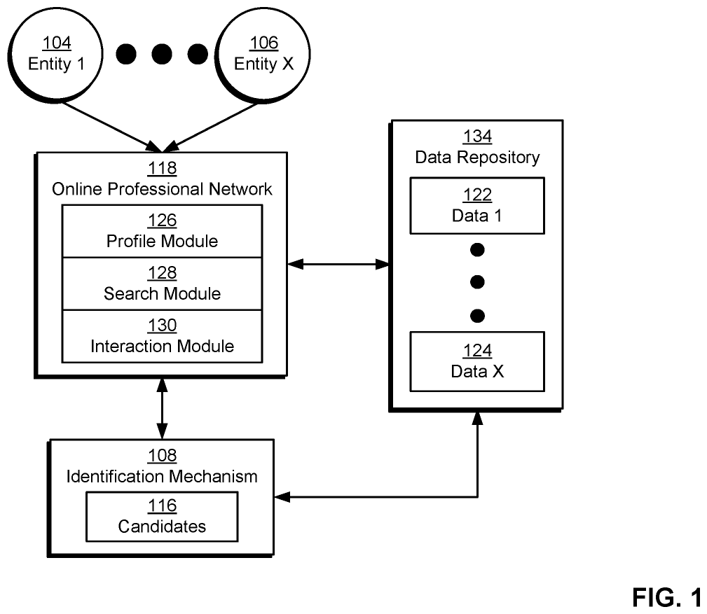

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, interaction with a job post, interaction with a hiring project, and/or other action performed by an entity in online network 118 may be tracked and stored in a database, data warehouse, cloud storage, and/or other data-storage mechanism providing data repository 134.

In turn, data in data repository 134 may be used to generate recommendations and/or other insights related to listing or placing jobs or opportunities. For example, one or more components of the online professional network may track searches, clicks, views, text input, conversions, and/or other feedback during the entities' interaction with a job search tool and/or recruiter search tool in online network 118. The feedback may be stored in data repository 134 and used as training data for one or more machine learning models, and the output of the machine learning model(s) may be used to display and/or otherwise recommend a number of job listings to current or potential job seekers in the online professional network.

More specifically, data in data repository 134 and one or more machine learning models are used to produce rankings of candidates 116 for jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strength of candidates 116 with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities, the number of times the candidate has been previously viewed and/or saved by recruiters and/or job posters, and/or other factors. The model(s) may further adjust the scores based on social and/or other validation of the candidates' profile data (e.g., endorsements of skills, recommendations, accomplishments, awards, patents, publications, reputation scores, etc.). The rankings may then be generated by ordering candidates 116 by descending score.

The rankings and/or associated insights may improve the quality of candidates 116 and/or recommendations of opportunities to candidates 116, increase user activity with online network 118, and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates 116 for a job to encourage the member to apply for jobs in which the member is highly ranked. In a second example, the component(s) may account for a candidate's relative position in rankings for a set of jobs during ordering of the jobs as search results in response to a job search by the candidate. In a third example, a ranking of candidates 116 for a given set of job qualifications may be displayed as search results to a recruiter after the recruiter performs a search with the job qualifications included as parameters of the search.

On the other hand, machine learning models used to rank and/or recommend candidates 116 for opportunities may be created using limited and/or conflicting training data that is generated from actions of moderators with respect to previous rankings of candidates 116 outputted by the machine learning models. For example, a recruiter may input different combinations of search parameters in a series of queries to search for candidates matching a position. When the recruiter performs a positive action (e.g., message, save, click, etc.) on a candidate shown in a set of search results, a positive label may be associated with the query used to produce the search results. Conversely, previous queries by the recruiter for the same position may lack positive labels for the candidate, even though those queries were performed with the same hiring intent. Instead, such queries may include negative labels representing a lack of action by the recruiter on the candidate, resulting in conflicting labels for the same candidate and similar queries.

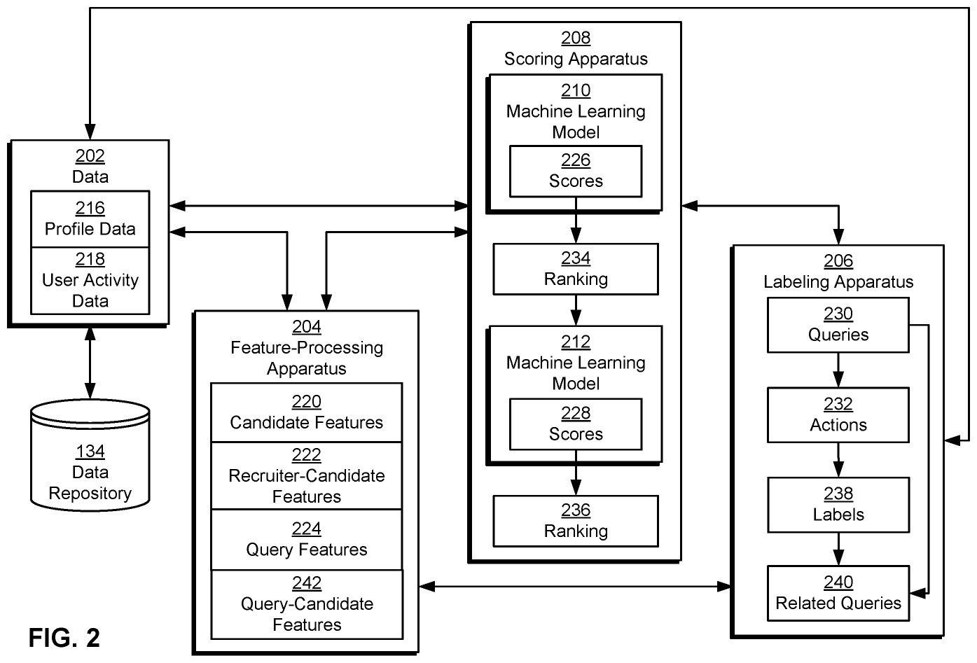

In one or more embodiments, online network 118 includes functionality to improve the accuracy and/or relevance of rankings and/or recommendations of candidates 116 for opportunities by increasing positive labels and/or reducing conflicting labels in training data for the machine learning models. As shown in FIG. 2, data 202 from data repository 134 is used to generate rankings 234-236 of candidates in response to queries 230. Data 202 includes profile data 216 for members of an online community (e.g., online network 118 of FIG. 1), as well as user activity data 218 that tracks the members' and/or candidates' activity within and/or outside the community.

Profile data 216 includes data associated with member profiles in the community. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the community.

Attributes of the members may be matched to a number of member segments, with each member segment containing a group of members that share one or more common attributes. For example, member segments in the community may be defined to include members with the same industry, title, location, and/or language.

Connection information in profile data 216 may additionally be combined into a graph, with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the community. For example, user activity data 218 may be used to track impressions, clicks, likes, dislikes, shares, hides, comments, posts, updates, conversions, and/or other user interaction with content in the community. User activity data 218 may also, or instead, track other types of community activity, including connections, messages, job applications, job searches, recruiter searches for candidates, interaction between candidates 116 and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users. Like profile data 216, user activity data 218 may be used to create a graph, with nodes in the graph representing community members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

Profile data 216, user activity data 218, and/or other data 202 in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In one or more embodiments, a scoring apparatus 208 uses data 202 in data repository 134 to identify and/or order candidates that match parameters of queries 230. For example, a recruiter and/or another entity involved in hiring or recruiting may generate a query by specifying parameters related to candidates for a position and/or a number of related positions using checkboxes, radio buttons, drop-down menus, text boxes, and/or other user-interface elements in a recruiting module or tool.

Queries 230 include attributes that are desired or required by the position(s). For example, queries 230 may include thresholds, values, and/or ranges of values for an industry, location, education, skills, past positions, current positions, seniority, overall qualifications, title, seniority, keywords, awards, publications, patents, licenses and certifications, and/or other attributes or fields associated with profile data 216 for the candidates. To improve the quality and/or relevance of search results for a given query, candidates that meet the criteria represented by parameters of the query are ordered in the search results based on features associated with the candidates and/or the recruiter performing the search.

As shown in FIG. 2, a feature-processing apparatus 204 calculates the features using data 202 from data repository 134. Such calculations may occur on an offline, periodic, or batch-processing basis to produce features for a large number of candidates. Some or all features may also, or instead, be generated in an online, nearline, and/or on-demand basis based on recent search parameters by recruiters and/or other users performing queries 230.

In one or more embodiments, features used to produce results of queries include candidate features 220, recruiter-candidate features 222, query features 224, and query-candidate features 242. Candidate features 220 may be generated for a set of candidates with attributes that match or meet parameters of queries 230, recruiter-candidate features 222 may be generated for each recruiter-candidate pair, query features 224 may be generated for individual queries 230, and query-candidate features 242 may be generated for each query-candidate pair.

Candidate features 220 include features related to each candidate's compatibility with queries 230. For example, candidate features 220 may include each candidate's name, school, title, seniority, employment history, skills, recommendations, endorsements, awards, honors, publications, and/or other attributes that relate, directly or indirectly, to parameters of queries 230 inputted by the recruiter. Candidate features 220 may also, or instead, include reputation scores for skills specified in queries 230 and/or other measures of the candidate's qualifications.

Candidate features 220 may further characterize the job-seeking behavior and/or preferences of each candidate. For example, candidate features 220 may include a job-seeker score that classifies the member's job-seeking status as a job seeker or non-job-seeker and/or estimates the member's level of job-seeking interest. In another example, candidate features 220 may include the amount of time since a candidate has expressed openness or availability for new opportunities (e.g., as a profile setting and/or job search setting). In a third example, candidate features 220 may include views, searches, applications, and/or other activity of the member with job postings in the social network and/or views or searches of company-specific pages in the social network.

Candidate features 220 may also, or instead, include measures of the candidate's popularity with recruiters and/or the candidate's willingness to interact with recruiters. For example, candidate features 220 related to a candidate's popularity may include the number of messages sent to the candidate by recruiters, the number of recruiter messages accepted by the candidate, a percentage of messages accepted by the candidate, message delivery settings of the candidate, and/or the number of times the candidate has been viewed in search results by recruiters.

Recruiter-candidate features 222 describe interaction and/or interest between the recruiter and each candidate. For example, recruiter-candidate features 222 may include the number of times the recruiter has viewed a given candidate within the recruiting tool and/or in search results. In another example, recruiter-candidate features 222 may include an affinity score between the recruiter and the candidate, which is calculated using a matrix decomposition of messages sent and/or accepted between a set of recruiters and a set of candidates.

Query features 224 characterize a given query. For example, query features 224 may include representations of parameters of the query and/or a context of the query (e.g., a tool, module, platform, application, device, and/or location from which the query was performed).

Query-candidate features 242 describe interaction and/or compatibility between a query and each candidate. For example, query-candidate features 242 may include a match score between the query and candidate, which can be calculated as a cross product, vector similarity (e.g., cosine similarity, Jaccard similarity, etc.), and/or other measure of similarity between the member's profile data 216 and parameters of the query.

A scoring apparatus 208 inputs candidate features 220, recruiter-candidate features 222, query features 224, and/or query-candidate features 242 into one or more machine learning models 210-212 to generate one or more sets of scores 226-228 for the candidates. Each set of scores 226-228 is then used to produce a corresponding ranking (e.g., rankings 234-236) of the candidates, and one or more rankings are used to populate search results that are returned in response to a given query.

For example, machine learning models 210-212 may include decision trees, random forests, and/or gradient boosted trees that generate multiple rounds of scores 226-228 and/or rankings 234-236 for the candidates according to different sets of criteria and/or thresholds. Each score generated by one or both machine learning models 210-212 may represent the likelihood of a candidate accepting a message from a recruiter and/or of another positive outcome, given an impression of the candidate by the recruiter in search results 232. Thus, an improvement in the performance and/or precision of one or both machine learning models 210-212 may produce a corresponding increase in the rate of message acceptances by candidates after the candidates are viewed by recruiters in search results 232.

Continuing with the above example, scoring apparatus 208 may use machine learning model 210 to generate a first set of scores 226 from candidate features 220, recruiter-candidate features 222, query features 224, and/or query-candidate features 242 for all candidates that match parameters of a query (e.g., all candidates returned by data repository 134 in response to the parameters). Scoring apparatus 208 may also generate ranking 234 by ordering the candidates by descending score from the first set of scores 226.

Next, scoring apparatus 208 may obtain a highest-ranked subset of candidates from ranking 234 (e.g., the top 1,000 candidates in ranking 234) and input additional candidate features 220, recruiter-candidate features 222, query features 224, and/or query-candidate features 242 for the highest-ranked subset of candidates into machine learning model 212. Scoring apparatus 208 may then obtain a second set of scores 228 from machine learning model 212 and generate ranking 236 by ordering the subset of candidates by descending score from the second set of scores 228. As a result, machine learning model 210 may perform a first round of scoring and ranking 234 and/or filtering of the candidates using a first of criteria, and machine learning model 212 may perform a second round of scoring and ranking 234 of a smaller number of candidates using a second set of criteria. The number of candidates scored by machine learning model 212 may be selected to accommodate performance and/or scalability constraints associated with generating results in response to queries 230 by a large number of recruiters and/or other entities.

Scores 226-228 and/or rankings 234-236 from scoring apparatus 208 are then used to generate search results that are displayed and/or outputted in response to the corresponding queries 230. For example, some or all candidates in ranking 236 may be paginated into subsets of search results that are displayed as a recruiter scrolls through the search results and/or navigates across screens or pages containing the search results.

In one or more embodiments, a labeling apparatus 206 generates labels 238 that reflect actions 232 performed by recruiters and/or other hiring entities in response to queries 230 and/or the corresponding search results. For example, a recruiter may perform a series of related queries 230 (e.g., queries containing parameters of “Software Engineer,” “Software Engineer AND skill=Java,” and “Software Engineer AND skill=Java OR Python”) to search for candidates for a particular opportunity (e.g., a software engineer position). After the recruiter finds a promising or interesting candidate in a given set of search results, the recruiter may perform a positive action on the candidate (e.g., clicking on the candidate, messaging the candidate, saving the candidate, etc.) within a certain timeframe of the query used to produce the search results (e.g., a certain number of minutes, hours, and/or days after the query). In turn, labeling apparatus 206 may detect the positive action within the timeframe of the query (e.g., by joining records of queries 230 and/or search results associated with the recruiter with records of actions 232 performed by the recruiter) and generate a positive label (e.g., labels 238) for the query to reflect the positive action.

Labels 238 from labeling apparatus 206 are then used to update machine learning models 210-212. For example, labels 238 may be combined with candidate features 220, recruiter-candidate features 222, query features 224, and/or query-candidate features 242 for the corresponding queries 230, candidates, and/or recruiters to produce training data for one or both machine learning models 210-212, and scoring apparatus 208 and/or another component of the system may use a training technique and/or one or more hyperparameters to update parameters of machine learning models 210-212 based on labels 238 and the corresponding features. Consequently, the output of machine learning models 210-212 may reflect preferences and/or behavior of recruiters and/or candidates over time.

In one or more embodiments, labeling apparatus 206 includes functionality to improve the number and/or consistency of labels 238 by transferring labels 238 from queries 230 associated with positive actions 232 to related queries 240 that are iteratively reformulated to produce queries 230 and/or positive actions 232. In particular, labeling apparatus 206 identifies, for a given query resulting in a positive action and/or label, related queries 240 as queries performed by the same entity as the query within a time window preceding the query. For example, labeling apparatus 206 may obtain related queries 240 as queries performed within a certain number of hours or days before the query by the recruiter, contract, and/or hiring entity that performed the query.

Labeling apparatus 206 optionally identifies related queries 240 based on additional attributes associated with the query. For example, labeling apparatus 206 may remove queries that do not produce search results containing the candidate to which the positive action was applied from related queries 240. In other words, all related queries 240 to which a given positive action can be attributed may involve the same entity performing the action resulting in the positive label and the same candidate to which the action is applied.

In another example, labeling apparatus 206 may use a logistic regression model and/or other type of classification model to predict a similar “hiring intent” between the query and each query by the same entity within the time window. Features inputted into the classification model may include, but are not limited to, textual similarities between the queries and/or behavioral features associated with the entity and/or candidates with which the entity interacts as a result of the queries. A threshold may be applied to similarity scores outputted by the classification model to identify related queries 240 as queries with similarity scores that exceed the threshold.

After related queries 240 are identified for a query associated with a positive label, labeling apparatus 206 generates additional positive labels 238 for related queries 240. For example, labeling apparatus 206 may assign each positive label to a triplet of (recruiter, related query, candidate) associated with the original query and/or positive label. If a negative label is associated with the triplet (e.g., in response to a lack of positive action by the recruiter on the candidate after the related query is performed), labeling apparatus 206 may replace the negative label with the positive label to reduce conflicting labels 238 for queries 230 and/or related queries 240. Additional labels 238 for related queries 240 may then be combined with features from feature-processing apparatus 204 to produce training data that is used to update machine learning models 210-212, as discussed above.

By attributing positive labels and/or outcomes across queries that are reformulated to reach the outcomes, the disclosed embodiments may increase the number of positive labels and/or improve the distribution of queries in training data for machine learning models that produce rankings in response to the queries. In contrast, conventional techniques may generate training data based on strict attributions of outcomes to queries that lead directly to the outcomes, which may limit positive labels in the training data and/or generate conflicting labels for related or similar queries (e.g., a negative label for a lack of action on a candidate after a first query and a positive label for a positive action on the candidate after a second, more targeted query). Consequently, the disclosed embodiments may improve computer systems, applications, user experiences, tools, and/or technologies related to user recommendations, machine learning, employment, recruiting, and/or hiring.

Those skilled in the art will appreciate that the system of FIG. 2 may be implemented in a variety of ways. First, feature-processing apparatus 204, scoring apparatus 208, labeling apparatus 206, and/or data repository 134 may be provided by a single physical machine, multiple computer systems, one or more virtual machines, a grid, one or more databases, one or more filesystems, and/or a cloud computing system. Feature-processing apparatus 204, scoring apparatus 208, and labeling apparatus 206 may additionally be implemented together and/or separately by one or more hardware and/or software components and/or layers.

Second, a number of machine learning models and/or techniques may be used to generate scores 226-228 and/or rankings 234-236. For example, the functionality of each machine learning model may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may also be performed on an offline, online, and/or on-demand basis to accommodate requirements or limitations associated with the processing, performance, or scalability of the system and/or the availability of features used to train the machine learning model. Multiple versions of a machine learning model may further be adapted to different subsets of candidates, recruiters, and/or queries (e.g., different member segments in the community), or the same machine learning model may be used to generate one or more sets of scores (e.g., scores 226-228) for all candidates and/or recruiters in the community. Similarly, the functionality of machine learning models 210-212 may be merged into a single machine learning model that performs a single round of scoring and ranking of the candidates and/or separated out into more than two machine learning models that perform multiple rounds of scoring, filtering, and/or ranking of the candidates.

Third, the system of FIG. 2 may be adapted to various types of searches and/or entities. For example, the functionality of the system may be used to improve search results and/or rankings containing candidates for academic positions, artistic or musical roles, school admissions, fellowships, scholarships, competitions, club or group memberships, matchmaking, and/or other types of opportunities.

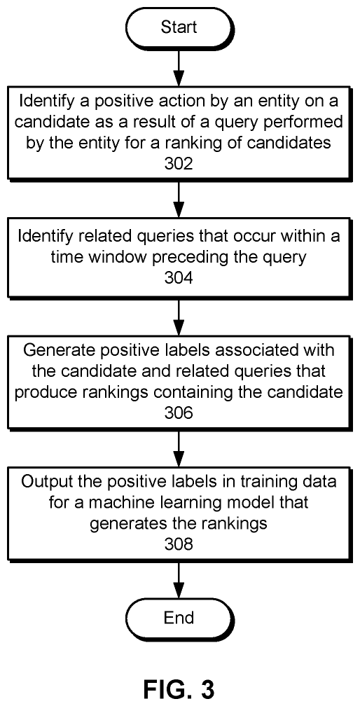

FIG. 3 shows a flowchart illustrating a process of generating training data for a machine learning model in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a positive action by an entity on a candidate as a result of a query performed by the entity for a ranking of candidates is identified (operation 302). For example, the positive action may include transmission of a message to the candidate, clicking on the candidate within the ranking, saving the candidate, and/or another action that indicates interest in the candidate by the entity. The positive action may be identified within a time window following the query (e.g., a certain number of minutes, hours, or days after the query). As a result, the positive action may be identified within a different context from that of the query, such as within a “saved candidates” or “projects” module of a hiring or recruiting tool in which the candidate was stored.

Next, related queries that occur within a time window preceding the query are identified (operation 304). For example, the related queries may include additional queries performed by the entity within the time window preceding the query and/or queries that have similar intent to the query.

Positive labels associated with the candidate and related queries that produce rankings containing the candidate are then generated (operation 306). For example, a positive label may be assigned to a triplet containing the candidate, entity, and each related query of the query that produces search results containing the candidate.

Finally, the positive labels are outputted in training data for a machine learning model that generates the rankings (operation 308). For example, the positive labels may be associated with features for the candidate and corresponding queries in the training data. The features may include query features associated with the queries, candidate features for the candidate, query-candidate features representing compatibility between the candidate and the queries, and/or recruiter-candidate features representing a level of interest between the entity and the candidate. The training data may then be used to update the parameters of the machine learning model and improve the performance of the machine learning model.

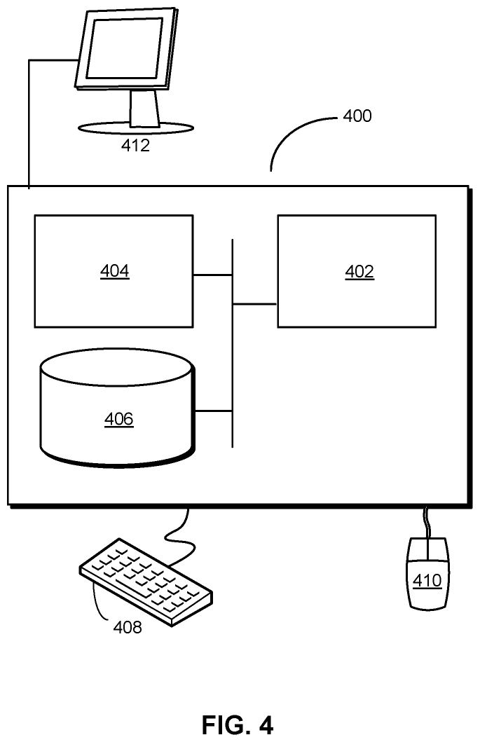

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system. In one or more embodiments, computer system 400 provides a system for processing data. The system includes a feature-processing apparatus, a scoring apparatus, and a labeling apparatus, one or more of which may alternatively be termed or implemented as a module, mechanism, or other type of system component. The feature-processing apparatus generates features for ordering candidates that match parameters of a query by an entity. Next, the scoring apparatus applies a machine learning model to the features to produce a ranking of the candidates. The labeling apparatus then identifies a positive action by an entity on a candidate as a result of the query. The labeling apparatus also identifies related queries that occur within a time window preceding the query. The labeling apparatus subsequently generates positive labels associated with the candidate and one or more related queries that produce rankings containing the candidate. Finally, the labeling apparatus outputs the positive labels in training data for a machine learning model that generates the rankings.

In addition, one or more components of computer system 400 may be remotely located and connected to the other components over a network. Portions of the present embodiments (e.g., feature-processing apparatus, scoring apparatus, labeling apparatus, data repository, online network, etc.) may also be located on different nodes of a distributed system that implements the embodiments. For example, the present embodiments may be implemented using a cloud computing system that transfers positive labels across queries performed by a set of remote recruiters and/or entities.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
identifying a positive action by an entity on a candidate as a result of a query performed by the entity for a ranking of candidates;
identifying, by one or more computer systems, related queries that occur within a time window preceding the query;
generating, by the one or more computer systems, positive labels associated with the candidate and one or more of the related queries that produce rankings containing the candidate; and
outputting the positive labels in training data for a machine learning model that generates the rankings.

2. The method of claim 1, wherein identifying the positive action on the candidate in the ranking of candidates generated in response to the query comprises:
identifying the positive action on the candidate within another time window following the query.

3. The method of claim 1, wherein identifying the related queries that occur within the time window preceding the query comprises:
obtaining the related queries as additional queries performed by the entity within the time window preceding the query.

4. The method of claim 1, wherein the entity comprises at least one of:
a recruiter; and
a hiring entity.

5. The method of claim 1, wherein identifying the related queries that occur within the time window preceding the query comprises:
identifying the related queries as having similar intent to the query.

6. The method of claim 1, wherein generating the positive labels associated with the candidate and the one or more of the related queries that produce search results containing the candidate comprises:
replacing a negative label associated with the candidate and a related query in the one or more of the related queries with a positive label associated with the candidate and the related query.

7. The method of claim 1, wherein outputting the positive labels in training data for the machine learning model comprises:
associating, in the training data, the positive labels with features for the candidate and the one or more of the related queries.

8. The method of claim 7, wherein the features comprise at least one of:
a query feature associated with the one or more of the related queries; and
a candidate feature for the candidate.

9. The method of claim 7, wherein the features comprise at least one of:
a query-candidate feature representing a compatibility between the candidate and the one or more of the related queries; and
a recruiter-candidate feature representing a level of interest between the entity and the candidate.

10. The method of claim 1, wherein the query comprises at least one of:
a title;
a skill;
an industry;
a location;
a seniority;
an educational background;
a company; and
a keyword.

11. The method of claim 1, wherein the positive action comprises at least one of:
clicking on the candidate;
saving the candidate; and
transmitting a message to the candidate.

12. A system, comprising:
one or more processors; and
memory storing instructions that, when executed by the one or more processors, cause the system to:
identify a positive action by an entity on a candidate as a result of a query performed by the entity for a ranking of candidates;
identify related queries that occur within a time window preceding the query;
generate positive labels associated with the candidate and one or more of the related queries that produce rankings containing the candidate; and
output the positive labels in training data for a machine learning model that generates the rankings.

13. The system of claim 12, wherein identifying the positive action on the candidate in the ranking of candidates generated in response to the query comprises:
identifying the positive action on the candidate within another time window following the query.

14. The system of claim 12, wherein identifying the related queries that occur within the time window preceding the query comprises at least one of:
obtaining the related queries as additional queries performed by the entity within the time window preceding the query; and
identifying the related queries as having similar intent to the query.

15. The system of claim 12, wherein generating the positive labels associated with the candidate and the one or more of the related queries that produce search results containing the candidate comprises:
replacing a negative label associated with the candidate and a related query in the one or more of the related queries with a positive label associated with the candidate and the related query.

16. The system of claim 12, wherein outputting the positive labels in training data for the machine learning model comprises:
associating, in the training data, the positive labels with features for the candidate and the one or more of the related queries.

17. The system of claim 12, wherein the query comprises at least one of:
a title;
a skill;
an industry;
a location;
a seniority;
an educational background;
a company; and
a keyword.

18. The system of claim 12, wherein the positive action comprises at least one of:
clicking on the candidate;
saving the candidate; and
transmitting a message to the candidate.

19. A non-transitory computer-readable storage medium storing instructions that when executed by a computer cause the computer to perform a method, the method comprising:
identifying a positive action by an entity on a candidate as a result of a query performed by the entity for a ranking of candidates;
identifying related queries that occur within a time window preceding the query;
generating positive labels associated with the candidate and one or more of the related queries that produce rankings containing the candidate; and
outputting the positive labels in training data for a machine learning model that generates the rankings.

20. The non-transitory computer-readable medium of claim 19, wherein identifying the related queries that occur within the time window preceding the query comprises:
obtaining the related queries as additional queries performed by the entity with a similar intent to the query.
